(19) United States
(12) Patent Application Publication
(10) Pub. No.: US 2004/0249949 A1
(43) Pub. Date: Dec. 9, 2004

(54) Voice and multimedia distribution using Push-To-Talk (PTT) subscribers' group

(76) Inventors: Christophe Gourraud, Montreal (CA); Samer Hawwa, Montreal (CA)

Correspondence Address: Alex Nicolaescu, Ericsson Canada Inc., Patent Department, 8400 Decaire Blvd., Town Mount Royal, QC, H4P 2N2, CA

(21) Appl. No.: 10/397,800

(22) Filed: Mar. 27, 2003

(51) Int. Cl. G06F 15/16

(52) U.S. Cl. 709/227

(57) ABSTRACT

A method, system and Application Server (AS) for distributing Push-To-Talk (PTT) voice and multimedia messages to communities of subscribers, using a definition os PTT groups. First, a PTT group of subscribers is created in the AS, either by one of the members or by a content provider server. Then, the subscribers register their interest in receiving PTT messages related to the created group, for example by joining a Session Initiation Protocol (SIP) related to that group. Finally, the content provider server sends a PTT message destined to the PTT group, the message comprising voice and/or multimedia information, such as for example news, stock quotes, sport updates, weather or commercial information. The message is received by the AS, which distributes it to the registered subscribers of the PTT group using its definition of the PTT group.

### BACKGROUND OF THE INVENTION

1. Field of the Invention

The present invention relates to the distribution of voice and multimedia information using Push-To-Talk (PTT) subscribers' group.

2. Description of the Related Art

Push-To-Talk (PTT) defines a functionality wherein a user can simply push a button (or click or otherwise activate a key) of his communication terminal in order to have its voice being transmitted from its terminal to one or more other communications terminals. A wide range of variants of the PTT functionality have been implemented in different telecommunications systems in the industry, ranging from the simple radio walkie-talkies to more complex software applications running on top of Personal Computers (PCs) connected via the Internet, further to cellular telecommunications systems, wherein the subscribers make use of the cellular system to send their voice message.

Nowadays, PTT is been also implemented in the cellular General Packet Radio Service (GPRS) systems. According to this implementation, GPRS users receiving the transmission hear the sender's voice automatically without having to answer the call. In this implementation, PTT is based on the IP Multimedia System (IMS), a technology standardized by the Third Generation Partnership Projects (3GPP). IMS adds two features on top of the packet-switched domain: it gives the ability to find a person via Session Initiation Protocol (SIP) to initiate a session, and provides the ability to integrate new revenue services, such as PTT.

Reference is now made to FIG. 1.a (Prior Art) that shows a simplified high-level network diagram of a system 10 with an existing PTT functionality that may be implemented in a cellular GPRS network. Shown in FIG. 1 are, first, four (4) User Equipments (UE): UE₁ 12, UE₂ 14, UE₃ 16, and UE₄ 18. UE₁ 12 is provided wireless cellular service via a first wireless network 20, while UE₂ 14, UE₃ 16, and UE₄ 18 receive wireless cellular service via a second wireless network 22. Both networks 20 and 22 are connected to a Session Initiation Protocol (SIP) Application Server (AS) 24, which comprises a PTT module 26 responsible for the provision of the PTT service to the subscribers of the networks 20 and 22. In the implementation shown in FIG. 1.a, first, a subscriber, such as for example the subscriber of the UE₂ may define a group of subscribers, comprising, for example, subscribers of the UE₁, UE₂, UE₃, and UE₄. Then, the subscribers may register with the PTT module 26 of the application server 24 to inform the network that they are ready to receive PTT messages related to that group. Finally, when anyone of the registered group subscribers pushes the button to send the PTT message, his voice is transmitted via its respective network 20 or 22 via the AS 24 to all the remaining registered members of the group.

In this manner, small communities of persons that are defined in the same PTT group can communicate with each other by making use of the PTT functionality.

Reference is now made to FIG. 1.b (Prior Art) illustrating a high-level flowchart diagram of a flow of actions performed for sending a PTT message in the previously described network 10. In action 100, the first user creates the users group, then in action 102, some, or all of the group's subscribers register with the AS 24 so that the network knows that they are ready to receive PTT messages. Finally, in action 104, anyone of the registered users sends a PTT voice message to the other members of the group, and in action 106, the PTT voice message is delivered to the targeted members of the group, and played on their terminals.

Although there is no prior art solution as the one proposed hereinafter, the UK Patent Application GB 2,290,196 bears some relation with the present invention. In the UK Patent Application GB 2,290,196, there is disclosed a system for reducing access time in a PTT system. The system includes a unit with a list of ID numbers for members of a talk group held in memory. A paging command for a selected ID can be transmitted over a control channel, and a traffic channel is selected for further communication on receipt of a channel grant command. A second unit receives a paging command with an ID and a group channel grant command over the control channel and receives traffic over a traffic channel. The ID is compared with the ID for the second unit and the unit, which is being paged, is determined. An alert signal is generated in response to the paging command. A PTT command is input at a switch and a group call request is transmitted over the control channel. A central unit repeats the paging commands and traffic. Group call channel grant commands are transmitted in response to group call requests when a traffic channel is available. If the target unit PTT switch and is not operated within a preset time, the alert signal stops but a visual signal indicates someone has called.

To date, the use of the PTT technology has been limited to the transmission of voice messages. Furthermore, the PTT functionality has been also used only for the transmission of voice information that originates from a subscriber's terminal. However, this concept has only limited applications. For example, the existing PTT service architecture does not allow non-voice information to be transmitted. Moreover, it prevents information originating from a variety of non-terminal sources to be transmitted to the groups of subscribers.

Accordingly, it should be readily appreciated that in order to overcome the deficiencies and shortcomings of the existing solutions, it would be advantageous to have a new method and system for effectively allowing the transmission of voice and multimedia information from a third party content provider to a group of PTT subscribers. The present invention provides such a method and system.

### SUMMARY OF THE INVENTION

In one aspect, the present invention is a method for sending voice and multimedia information to subscribers of a telecommunications network, the method comprising the steps of:

creating a Push-To-Talk (PTT) group of subscribers in the telecommunications network;

receiving from a content provider server a PTT message destined to the PTT group; and

distributing the PTT message to one or more subscribers of the PTT group.

In another aspect, the present invention is a telecommunications network, comprising:

a plurality of subscribers' User Equipments (UEs);

an Application Server (AS) storing a definition of a Push-To-Talk (PTT) group of subscribers that include one or more UEs from the plurality of subscribers' UEs; and

a content provider server;

wherein the AS receives from the content provider server a PTT message destined to the PTT group, and distributes the PTT message to the one or more UEs of the PTT group.

In yet another aspect, the present invention is an Application Server (AS) for use in a telecommunications network, the AS comprising:

a group definition module for storing a definition of groups of User Equipments (UEs);

a Push-To-Talk (PTT) module for providing PTT communication service to at least to certain UEs of the telecommunications network; and

a content provider server;

wherein the AS receives from the content provider server a PTT message destined to a selected one of the groups of UEs, and distributes the PTT message to one or more UEs that are members of the selected group.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1.a (Prior Art) is a simplified high-level network diagram of an exemplary existing Push-To-Talk (PTT) functionality that may be implemented in a cellular General Packet Radio Service (GPRS) system;

FIG. 1.b (Prior Art) is a high-level flowchart diagram illustrative of a flow of actions performed for sending a PTT message;

FIG. 2.a is a simplified high-level network diagram of an exemplary PTT functionality implemented in a cellular system according to the preferred embodiment of the present invention;

FIG. 2.b is an exemplary table showing the subscribers' group definition in the Application Server (AS) according to the preferred embodiment of the present invention;

FIG. 3.a is a first part of an exemplary nodal operation and signal flow diagram illustrative of a cellular system implementing the preferred embodiment of the present invention; and

FIG. 3.b is a second part of the exemplary nodal operation and signal flow diagram illustrative of a cellular system implementing the preferred embodiment of the present invention.

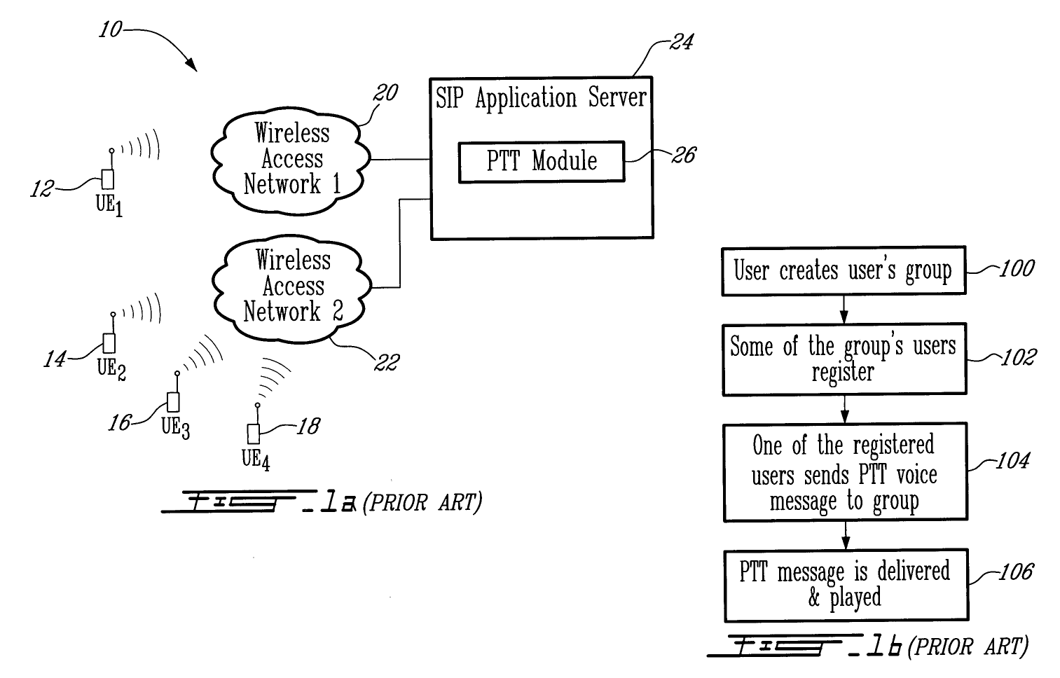

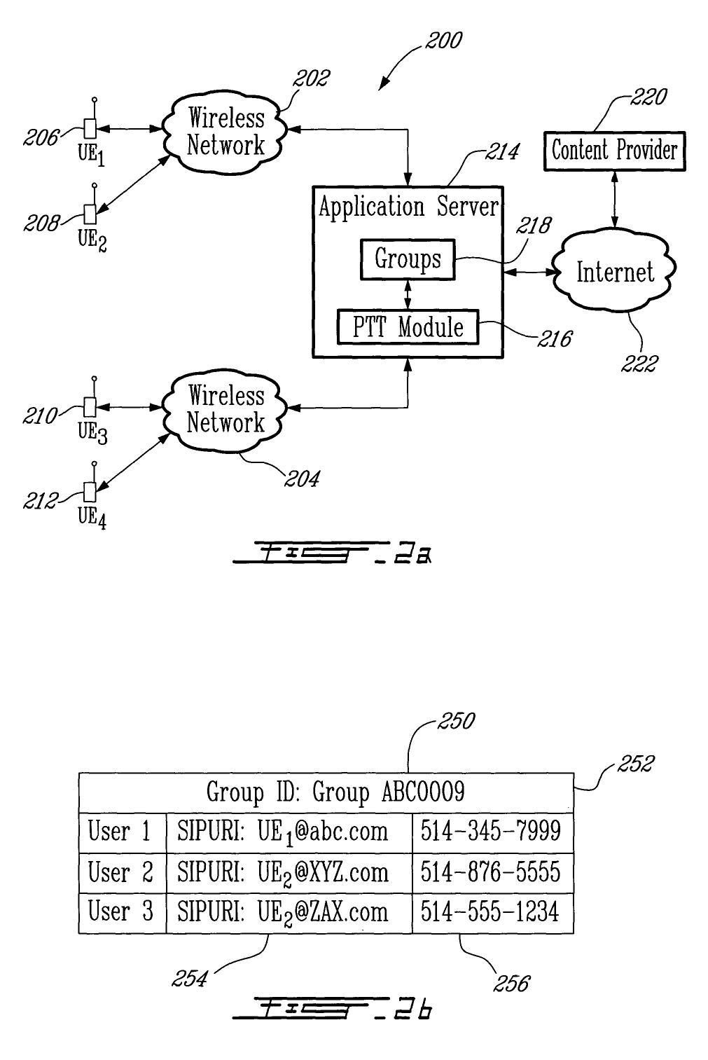

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention provides a new Push-To-Talk (PTT) service architecture along with corresponding method and system for allowing a content provider server to send voice and multimedia information to a subscribers' group defined in an Application Server (AS). The present invention, allows for content provider server to connect to the AS, and to broadcast voice and/or multimedia information to group members.

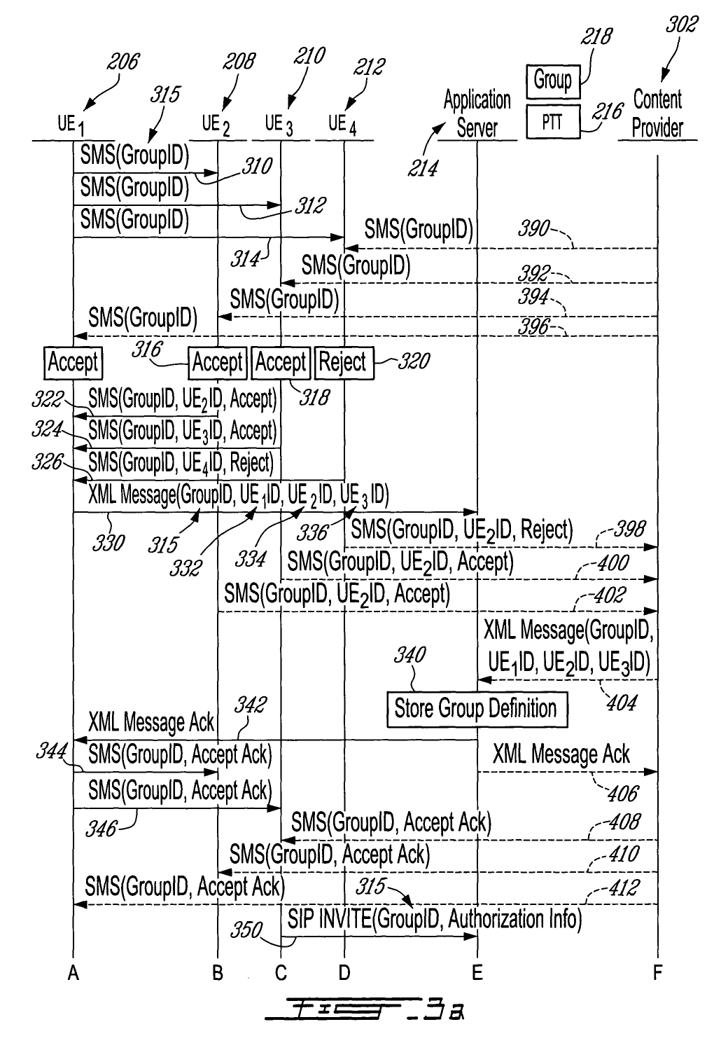

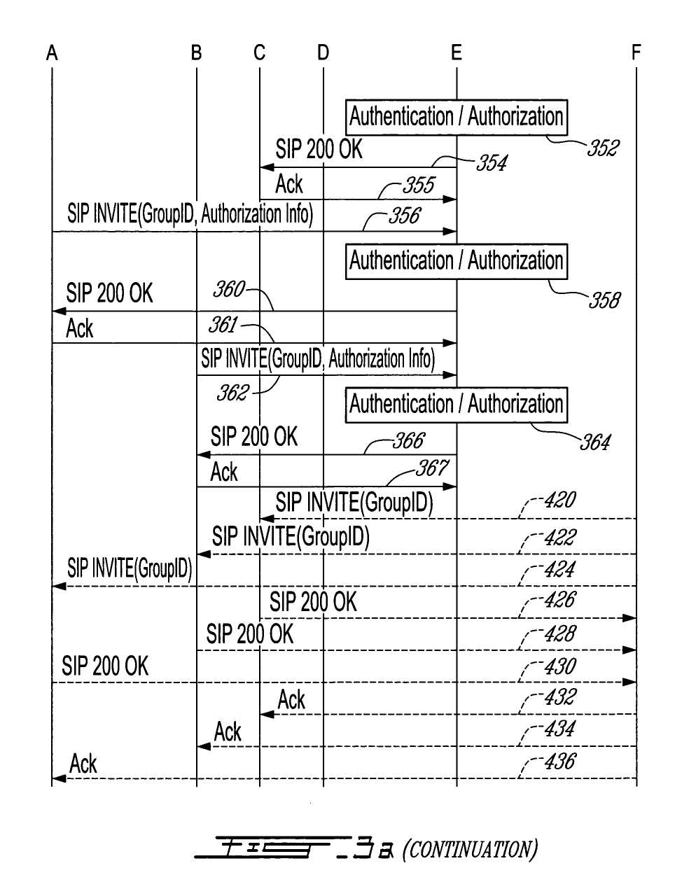

Reference is now made to FIG. 2.a, which is an exemplary high-level network diagram of a PTT functionality implemented in a cellular system 200 according to the preferred embodiment of the present invention. Shown in FIG. 2.a are two wireless networks 202 and 204 that provide cellular access to User Equipments (UE) UE₁ 206, UE₂ 208, UE₃ 210, and UE₄ 212. The two wireless networks 202 and 204 each connect to an Application Server (AS) 214 that is responsible for providing one or more services for the subscribers of the UEs 206-212. The AS 214 comprises a PTT module 216 that supports PTT service for said subscribers. The AS 214 may further comprise one or more groups definition module 218 where the subscriber groups information is stored.

With reference being now made to FIG. 2.b, the groups definition module 218 may comprise one or more group information tables alike the group definition table 250 shown in FIG. 2.b, which illustrates how a subscriber group may be defined. The group definition table 250 preferably comprises a group ID 252 that uniquely identifies that group of subscribers, and a list of subscribers' UEs that are members of the group. For each UE of the group, the group information table 250 may comprise an identifier 254ᵢ, such as for example an SIP Uniform Resource Indicator (URI) with an email address of the subscriber, and optionally, an E.164 telephone number 264ᵢ of that UE. In some implementations, the E.164 telephone number 264ᵢ may also be part of the SIP URI.

Reference is now made back to FIG. 2.a, wherein connected to the AS 214 is a content provider server 220 that may communicate with the AS 214 over the Internet 222. According to the preferred embodiment of the invention, the third party content provider 220 may use the PTT service functionality of the AS 214 for sending information of various types, such as for example commercial advertisements, news, stock quotes, sport updates or news, etc, to the group subscribers of the UEs 206-212, in the form of PTT voice or multimedia messages. This is achieved by using the subscribers' group definition of the group module 218 of the AS 214.

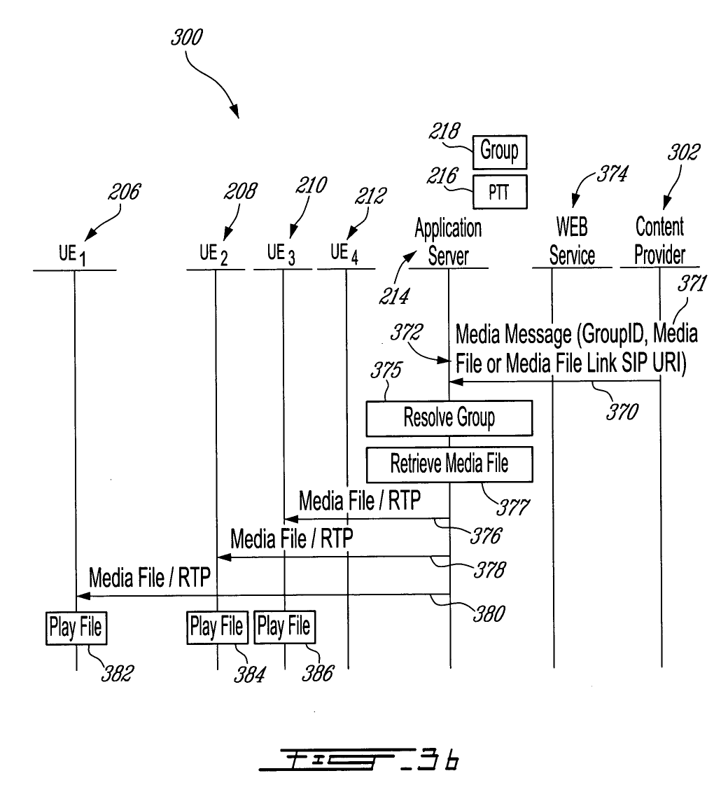

Reference is now made to FIG. 3, which is an exemplary nodal operation and signal flow diagram of a cellular system 300 implementing the preferred embodiment of the present invention that allows a content provider 302 to send voice or multimedia information to a community of UEs using the PTT service functionality defined in the AS 214. In FIG. 3, similar network functionalities are defined with the same numerals as the once previously used in relation to the FIG. 2.

In the exemplary scenario shown in FIG. 3, firstly, a PTT subscribers group has to be defined. According to a first exemplary scenario shown in FIG. 3.a, the subscriber of the UE₁ 206 is the one who initiates the creation of the PTT group, by sending Short Message Service (SMS) Messages 310, 312, and 314 to subscribers of UE₂ 208, UE₃ 210, and UE₄ 212, for inviting them in joining a new PTT group.

It is to be noted that signalling relevant to the first exemplary scenario, wherein a subscriber is the initiator of the creation of the subscribers' group is represented throughout FIG. 3 with plain lines, a opposed to the dotted lines that relate to a second exemplary scenario that is yet to be discussed further in the present description. With reference to the first exemplary scenario described in FIG. 3.a, a group identifier 315 that uniquely identifies the newly created group is included in each of the messages 310-314. In actions 316, 318, and 320, the subscribers of UE₂ 208 and UE₃ 210 accept the invitation to join the new group, while subscriber of the UE₄ 212 declines. Reply messages 322-326 with the appropriate response are sent back from the invited subscribers to the UE₁ 206, which in action 330 sends via an XML message the definition of the newly created group to the AS 414. The message 330 comprises the group identifier 315 and the UE identities 332, 334 and 336 of the PTT group members UE₁ 206, UE₂ 208 and UE₃ 210 respectively who accepted to be in the group. In action 340, the AS 214 stores the group definition information received in message 330 in a group definition module 218 and, in action 342, replies back to the UE₁ 206 with an acknowledgment message confirming the establishment of the new PTT group. Finally, the UE₁ 206 sends two SMS acknowledgment messages 344 and 246 for confirming the establishment of the new PTT group to the other group members UE₂ 208 and UE₃ 210 respectively.

According to an optional implementation of the first exemplary scenario of the preferred embodiment of the invention, although the PTT subscribers group is already created at this stage, PTT messages cannot be sent without first having the group members UEs to register their interest in receiving PTT messages from that group. For this purpose, a group member, say UE₃ 210, is the first to send a SIP INVITE message with the group ID and an authorization request to the AS 214, action 350, for registration with the group. In action 352, the AS 214 performs an authentication (provided the UE needs further authentication) and/or an authorization of the UE₃ 210, and if the result is a success, replies back to the UE₃ 210 with a 200 OK message 354 for confirming the registration of the UE₃ 210 with the group. The UE₃ 210 replies with an acknowledgement message 355. At that moment, the UE₃ 210 is ready to send or receive PTT messages in that PTT group.

At different moments, other group members, such as UE₁ 206 and UE₂ 208 may perform similar actions 356-367 and get registered with the AS 214 for PTT communications of that group, so that at a given point in time, all UE₁ 206, UE₂ 208, and UE₃ 210 are ready to send or receive PTT communications in that group.

According to a second exemplary scenario of the preferred embodiment of the present invention, the subscribers' group may be created in other manner as well than by one of the subscribers itself. For example, the content provider server 302 may be the one initiating the group creation for the purpose of sending information of various kinds to a community of subscribers. According to this variant, with reference being still further made to FIG. 3.a, instead of having the UE₁ 206 to send messages 310-314, it is the content provider server that sends equivalent messages 390-396 to UEs 206-212 for inviting them to join the new group. In this scenario, it is assumed that UE₁ 206, UE₂ 208, and UE₃ 210 accept the invitation, actions 313, 316, 318, while UE₄ 212 declines again, action 320. Actions 398-404 are then performed, which are analogous to the ones of steps 322-330, previously described, except for the fact that in the presently described second exemplary scenario, it is the content provider server, instead of the UE₁ 206, who is the initiator of the group creation. Messages 406-410 complete and confirm the creation of the new PTT group.

Once the content provider 302 creates the group, it may further invite the member UEs 206, 208 and 210 to register their interest in receiving PTT messages of the group, by sending SIP INVITE messages 420-424 to the three group members. It is assumed that all respond positively to the content provider with 200 OK messages 426-430, and that acknowledgement messages 432-436 finalise the registration of the group members.

Once any one of the first or second scenario (or any combination there between) is used for creating the subscribers' group, and for registration of the interest of the members in receiving or sending PTT messages, in action 370, the content provider server 302 may send a media message comprising a media file and the group ID 315, for the purpose of reaching the group members with the media message. The media message may comprise various kinds of information, such as for example but not limited to, news, sport scores, matches updates, commercial advertisement, announcements, etc, and may be sent to the AS 214 via a Web Service 374. The AS 214 resolves the subscribers group using the group ID 315, i.e. extracts the identities of the group members from the group information module 218 based on the received group ID 315, action 375, and sends the media file in actions 376, 378, and 380 to the group members UE₁ 206, UE₂ 208, and UE₃ 210, which each plays the file upon receipt, actions 382, 384, and 386 respectively.

In an alternate variant of the invention, in action 370, the content provider server 302 may rather send a media message comprising a link 371 to a media file rather than the entire media file itself, in order to save communications resources. The media message with the link, for example in the form of a SIP Uniform Resource Indicator (URI), may be sent to the AS 214 via the same Web Service 374. The AS 214 resolves the subscribers group using the group ID 315 as described hereinbefore, action 375, further retrieves the media file from the SIP URI, action 377, and finally sends the Media file in same actions 376, 378, and 380 to the group members UE₁ 206, UE₂ 208, and UE₃ 210, which each plays the file upon receipt, actions 382, 384, and 386 respectively.

Based upon the foregoing, it should now be apparent to those of ordinary skills in the art that the present invention provides an advantageous solution, which offers easy communication access for a third party content provider to PTT group subscribers for the purpose of allowing the transmission of voice and multimedia PTT messages to communities of users. Although the system and method of the present invention have been described in particular reference to certain exemplary scenarios, it should be realized upon reference hereto that the innovative teachings contained herein are not necessarily limited thereto and may be implemented advantageously with many alternative call scenarios, and any applicable radio telecommunications standard. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for sending voice and multimedia information to subscribers of a telecommunications network, the method comprising the steps of:
a) creating a Push-To-Talk (PTT) group of subscribers in the telecommunications network;
b) receiving from a content provider server a PTT message destined to the PTT group; and
c) distributing the PTT message to one or more subscribers of the PTT group.

2. The method claimed in claim 1, further comprising, prior to the step b), the step:
d) registering the one or more subscribers of the PTT group of subscribers with the telecommunications network.

3. The method claimed in claim 1, wherein the PTT message comprises voice information.

4. The method claimed in claim 3, wherein the voice information comprises a sound file.

5. The method claimed in claim 3, wherein the voice information comprises a link to a sound file.

6. The method claimed in claim 1, wherein the PTT message comprises multimedia information.

7. The method claimed in claim 6, wherein the multimedia information comprises a multimedia file.

8. The method claimed in claim 6, wherein the multimedia information comprises a link to a multimedia file.

9. The method claimed in claim 1, wherein step a) is initiated by one of the subscribers of the PTT group to be created.

10. The method claimed in claim 1, wherein step a) is initiated by the content provider server.

11. The method claimed in claim 1, wherein step a) includes the steps:
d) storing a group definition having:
i) a group identifier that uniquely identifies the PTT group, and
ii) a list of identifiers of User Equipments (UEs) associated with subscribers of the PTT group.

12. The method claimed in claim 2, wherein step d) includes joining the one or more subscribers in a Session Initiation Protocol (SIP) communications session related to the PTT group.

13. The method claimed in claim 1, wherein the PTT message comprises a group identifier that identifies the PTT group to which the PTT message is destined, and wherein the step c) comprises the step of associating the group identifier with identifiers of User Equipments (UEs) of subscribers of the PTT group.

14. A telecommunications network, comprising:
an Application Server (AS) storing a definition of a Push-To-Talk (PTT) group of subscribers that include one or more UEs; and
a content provider server;
wherein the AS receives from the content provider server a PTT message destined to the PTT group, and distributes the PTT message to the one or more UEs of the PTT group.

15. The telecommunications network claimed in claim 14, wherein after the PTT group is created, the one or more UEs register with the telecommunications network their interest in receiving PTT messages related to the PTT group.

16. The telecommunications network claimed in claim 14, wherein the PTT message comprises voice information.

17. The telecommunications network claimed in claim 16, wherein the voice information comprises a sound file.

18. The telecommunications network claimed in claim 16, wherein the voice information comprises a link to a sound file.

19. The telecommunications network claimed in claim 14, wherein the PTT message comprises multimedia information.

20. The telecommunications network claimed in claim 19, wherein the multimedia information comprises a multimedia file.

21. The telecommunications network claimed in claim 19, wherein the multimedia information comprises a link to a multimedia file.

22. The telecommunications network claimed in claim 14, wherein one of the subscribers of the PTT group to be created initiates a creation of the PTT group.

23. The telecommunications network claimed in claim 14, wherein the content provider server initiates a creation of the PTT group.

24. The telecommunications network claimed in claim 14, wherein the AS comprises a group definition module that stores the PTT group definition, the group definition module comprising:
i) a group identifier that uniquely identifies the PTT group, and
ii) a list of identifiers of the UEs of the PTT group.

25. The telecommunications network claimed in claim 14, wherein the UEs are joined in a Session Initiation Protocol (SIP) communications session related to the PTT group.

26. The telecommunications network claimed in claim 24, wherein the PTT message comprises the group identifier of the PTT group to which the PTT message is destined, and wherein the AS associates the group identifier with identifiers of the UEs of the PTT group.

27. An Application Server (AS) for use in a telecommunications network, the AS comprising:
a group definition module for storing a definition of groups of User Equipments (UEs); and
a Push-To-Talk (PTT) module for providing PTT communication service at least to certain UEs of the telecommunications network;
wherein the AS receives from the content provider server a PTT message destined to a selected one of the groups of UEs, and distributes the PTT message to one or more UEs that are members of the selected group.

28. The AS claimed in claim 27, wherein after the PTT group is created, the AS register the interest of the one or more UEs in receiving PTT messages related to the selected group.

29. The AS claimed in claim 27, wherein the PTT message comprises voice information.

30. The AS claimed in claim 29, wherein the voice information comprises a sound file.

31. The AS claimed in claim 29, wherein the voice information comprises a link to a sound file.

32. The AS claimed in claim 27, wherein the PTT message comprises multimedia information.

33. The AS claimed in claim 32, wherein the multimedia information comprises a multimedia file.

34. The AS claimed in claim 32, wherein the multimedia information comprises a link to a multimedia file.

35. The AS claimed in claim 27, wherein the group definition module stores:
iii) a group identifier that uniquely identifies the selected group of UEs, and
iv) a list of identifiers of the UEs of the selected group.

36. The AS claimed in claim 27, wherein the UEs are joined in a Session Initiation Protocol (SIP) communications session related to the group.

37. The AS claimed in claim 27, wherein the PTT message comprises the group identifier of the PTT group to which the PTT message is destined, and wherein the AS associates the group identifier with identifiers of the UEs of the selected group.
